(19) United States
(12) Patent Application Publication
(10) Pub. No.: US 2024/0200265 A1
(43) Pub. Date: Jun. 20, 2024

(54) COATING COMPOSITION AND ITS USES

(71) Applicants: DOW SILICONES CORPORATION, Midland, MI (US); DOW GLOBAL TECHNOLOGIES LLC, Midland, MI (US)

(72) Inventors: Yusheng CHEN, Shanghai (CN); Lili SHI, Shanghai (CN); Tingting CHEN, Shanghai (CN); Rui WANG, Shanghai (CN); Hongyu CHENG, Shanghai (CN); Yanli FENG, Shanghai (CN); Qing SHI, Shanghai (CN); Linfei WANG, Shanghai (CN)

(21) Appl. No.: 18/287,284

(22) PCT Filed: Mar. 11, 2021
(86) PCT No.: PCT/CN2021/080128

§ 371 Date: Oct. 17, 2023

(51) Int. Cl. D06N 3/14; C09D 7/20; C09D 7/62; C09D 183/04; D06N 3/00; D06N 3/12; D06N 3/18

(52) U.S. Cl. CPC D06N 3/144; C09D 7/20; C09D 7/62; C09D 183/04; D06N 3/0045; D06N 3/0063; D06N 3/007; D06N 3/0095; D06N 3/128; D06N 3/183

(57) ABSTRACT

A silicone/polyurethane synthetic leather topcoat composition is disclosed. The silicone/polyurethane synthetic leather topcoat composition is a hydrosilylation curable silicone elastomer composition which provides good adhesion to polyurethane and is used to provide a topcoat for a silicone/polyurethane composite synthetic leather material. The topcoat is the cured product of the composition. Also disclosed are methods of making the topcoat and the silicone/polyurethane composite synthetic leather material as well as uses of the silicone/polyurethane composite synthetic leather material.

The present disclosure relates to a silicone/polyurethane synthetic leather topcoat composition. The silicone/polyurethane synthetic leather topcoat composition is a hydrosilylation curable silicone elastomer composition which provides good adhesion to polyurethane and is used to provide a topcoat for a silicone/polyurethane composite synthetic leather material. The topcoat is the cured product of the composition. Also disclosed are methods of making the topcoat and the silicone/polyurethane composite synthetic leather material as well as uses of said synthetic leather material.

A variety of synthetic alternatives to natural leather have been developed. They are used in a wide variety of applications as cheap alternatives. Synthetic leathers are commonly used in applications such as furniture, decoration, handbags, luggage, garments, footwear, car interiors, car seats and the like.

One of the more common materials used for making synthetic leather is polyurethane (PU) which is an alternating copolymer generally prepared by reacting di or tri-isocyanates and a suitable polyol such as, for the sake of example, an alkylene polyol as depicted below, or a polyether polyol, a polyester polyol, or a polycarbonate polyol. The respective isocyanate and polyol, polymerise through the formation of carbamate/urethane links, such as shown below:

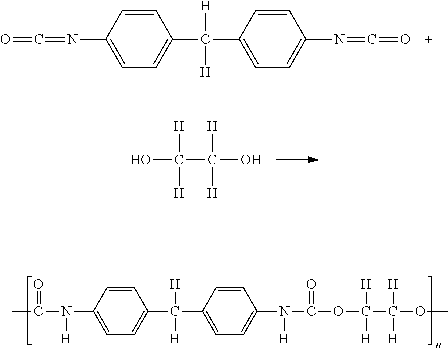

There are numerous alternative polyurethane (PU) based synthetic leather composite materials comprising several layers used as synthetic PU leathers. Perhaps one of the most common PU based synthetic leather composite materials typically comprises from bottom to top:
(i) a textile support layer,
(ii) a PU sponge/adhesive layer adhered/laminated to (i)
(iii) a PU “skin layer” adhered to the sponge/adhesive layer (ii) and finally
(iv) a PU topcoat, alternatively referred to as a “finishing layer” on the skin layer.
   In such a PU based synthetic leather composite material, for the avoidance of doubt, layer (ii) is substantially sandwiched between layers (i) and (iii) and layer (iii) is substantially sandwiched between layers (ii) and (iv). By “substantially” we mean that there are four distinct layers but there may be intermixing between layers at the interface between respective layers.

The use of PU based synthetic leather composite materials has several advantages over natural leather, not least it is much cheaper to produce and doesn't absorb water. It can be prepared in a variety of colors and unlike natural leather it doesn't dry out over time. However, it also has several problems including:
(i) having a fake and synthetic appearance which is often said to smell of plastic,
(ii) having poor weathering/ageing resistance over time not least because it can puncture or tear easily unlike genuine leather and
(iii) it won't develop the same luster or patina as real leather over time.
   Furthermore, to meet increasingly strict safety regulations, to be utilised as synthetic leather, they need to meet stringent physical property requirements, regarding e.g. flame retardancy, smoke density, suitable adhesion strength in order to allow a coating layer not to be peeled off at the time of usage, heat resistance, contamination resistance, solvent resistance, hydrolysis resistance, and the like, are required. Often the PU based materials cannot satisfy at least some of the above-mentioned physical property requirements.

Another group of synthetic alternatives to natural leather are silicone-based synthetic leather materials. Such silicone-based synthetic leather materials can have several advantages over the PU based materials discussed above. For example, they can generally be prepared using more eco-friendly production methods, using no plasticizer(s), toxic heavy metal(s) or environmentally problematic solvents such as dimethylformamide (DMF) which often remain, at least partially, in the synthetic leather product post manufacture.

Silicone-based synthetic leather composite materials may be made via several routes but are generally manufactured using a textile support layer and two or more layers of hydrosilylation curable liquid silicone rubber compositions and a release liner. For example, a first liquid silicone rubber (LSR) composition may be coated onto a release liner and is then cured to form a first or skin layer. A second LSR composition, usually having different physical properties to that of the first, is adhered to the cured first layer to form an adhesion layer and a textile support layer is adhered to the second LSR layer prior to cure, after which the second LSR composition is cured to form an adhesive layer situated between the skin layer and the textile support layer. One or more additional layers of hydrosilylation curable silicone elastomer composition may also be applied between the release liner and the textile layer as deemed appropriate to form a silicone-based leather composite material. For example, a third layer may be provided as a protective topcoat on top of the skin layer. The release liner is subsequently removed as and when required.

Such silicone-based synthetic leather composite materials are able to outperform conventional PU synthetic leather, from a physical property perspective because of the ability to provide, for example, better flexibility over a broad temperature range as well as excellent UV & thermal resistance. Topcoats are particularly important as they help to provide advantageous properties such as soil resistance. They also are considered to be kind to the human skin and to provide an excellent hand-feeling for users. However, such silicone-based synthetic leather composite materials are generally more expensive to prepare and therefore are perhaps not wholly suitable for all uses.

The concept of producing silicone/polyurethane composite synthetic leather materials, which might be considered an alternative approach has a fundamental problem in that it is very difficult to adhere layers of silicone materials to layers of polyurethane materials because silicone elastomeric materials and polyurethane have significantly different polarities resulting in only weak intermolecular attraction force and because they do not contain chemically active groups able to interact with each other.

Hence, the industry desires to provide silicone/polyurethane composite synthetic leather materials which can provide benefits from both the use of one or more PU layers in combination with a silicone based material topcoat which is provided as a replacement for the standard PU topcoat or finishing layer and which, upon cure, is capable of adhesion to the adjacent PU layer in the silicone/polyurethane composite synthetic leather material, often referred to as the PU “skin” layer.

There is provided a silicone/polyurethane synthetic leather topcoat composition comprising
Component (i), one or more organopolysiloxane polymer(s) having at least two unsaturated groups per molecule which unsaturated groups are selected from alkenyl groups, alkynyl groups or a mixture thereof; having a viscosity of from 100 to 500,000 mPa·s at 25° C.;
Component (ii) an inorganic reinforcing filler such as finely divided silica optionally hydrophobically treated with one or more filler treating agents;
Component (iii) a polyorganosiloxane containing at least two or alternatively at least three silicon bonded hydrogen (—Si—H) groups per molecule;
Component (iv) a hydrosilylation catalyst;
Component (v) an adhesion promoter comprising a combination of zirconium acetylacetonate in an amount of from 1 to 5 wt. % of the composition with 1,3,5-tris[3-(trimethoxysilyl)propyl]-1,3,5-triazine-2,4,6(1H,3H,5H)-trione, and/or one or more epoxy silanes of the formula

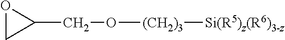

wherein R⁵ is an alkyl group having 1 to 6 carbons, R⁶ is an alkoxy group having 1 to 6 carbons and z=0, 1 or 2, or a mixture thereof, in an amount of from 1 to 6 wt. % of the composition; and
Component (vi) an eco-solvent; and optionally
Component (vii) a cured silicone powder.

The topcoat resulting from the cure of the above silicone/polyurethane synthetic leather topcoat composition is designed to provide a crosslinked silicone elastomeric matrix which readily adheres to polyurethane, specifically readily adheres to a polyurethane skin layer of a silicone/polyurethane synthetic leather but is also excellent in stain resistance i.e. the cured topcoat is easy to clean and has good scratch resistance.

There is also provided a silicone/polyurethane composite synthetic leather material having a topcoat in the form of a cured layer of the silicone/polyurethane synthetic leather topcoat composition as described herein.

There is also provided a silicone coating formed as a reaction product of the cure of the silicone/polyurethane synthetic leather topcoat composition described herein, methods of making the topcoat and the silicone/polyurethane composite synthetic leather material utilizing same and uses of products made out of the silicone/polyurethane composite synthetic leather material.

### (i) Organopolysiloxane Polymer(s)

Component (i) of the silicone/polyurethane synthetic leather topcoat composition one or more organopolysiloxane polymer(s) having at least two unsaturated groups per molecule, which unsaturated groups are selected from alkenyl groups, alkynyl groups or a mixture thereof; having a viscosity of from 100 to 500,000 mPa·s at 25° C.

Organopolysiloxane polymer (i) has multiple groups of the formula (I):

RₐSiO_{(4-a)/2} (I)

in which, providing it comprises the prerequisite number of unsaturated groups, each R is independently selected from an aliphatic hydrocarbyl, aromatic hydrocarbyl, or organyl group (that is any organic substituent group, regardless of functional type, having one free valence at a carbon atom). The groups may be in pendent positions (on a D or T siloxy group) or may be terminal (on an M siloxy group). Saturated aliphatic hydrocarbyls are exemplified by, but not limited to alkyl groups monovalent saturated hydrocarbon groups, which typically contain from 1 to 20 carbon atoms, such as methyl, ethyl, propyl, pentyl, octyl, undecyl, and octadecyl and cycloalkyl groups such as cyclohexyl. Unsaturated aliphatic hydrocarbyls are exemplified by, alkenyl groups having from 2 to 10 carbon atoms, such as vinyl, allyl, butenyl, pentenyl, isopropenyl, 5-hexenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups. Further organyl groups may include sulfur containing groups, phosphorus containing groups and/or boron containing groups. The subscript “a” may be 0, 1, 2 or 3, but is typically mainly 2 or 3.

Siloxy groups may be described by a shorthand (abbreviated) nomenclature, namely—“M,” “D,” “T,” and “Q”, when R is an organic group, typically methyl group (further teaching on silicone nomenclature may be found in Walter Noll, Chemistry and Technology of Silicones, dated 1962, Chapter I, pages 1-9). The M group corresponds to a siloxy group where a=3, that is R₃SiO_{1/2}; the D group corresponds to a siloxy group where a=2, namely R₂SiO_{2/2}; the T group corresponds to a siloxy group where a=1, namely R₁SiO_{3/2}; the Q group corresponds to a siloxy group where a=0, namely SiO_{4/2}.

The molecular structure of organopolysiloxane polymer (i) is typically linear, however, there can be some branching due to the presence of T groups (as previously described) within the molecule.

To achieve a useful level of physical properties in the elastomer prepared by curing the silicone/polyurethane synthetic leather topcoat composition as hereinbefore described, the viscosity of organopolysiloxane polymer (i) should be at least 100 mPa·s at 25° C. The upper limit for the viscosity of organopolysiloxane polymer (i) is limited to a viscosity of up to 500,000 mPa·s at 25° C.

The amount (wt. %) of unsaturated groups present is determined using quantitative infra-red analysis in accordance with ASTM E168. Component (i) has a viscosity of from 100 mPa·s to 500,000 mPa·s at 25° C., alternatively 200 mPa·s to 150,000 mPa·s at 25° C., alternatively from 200 mPa·s to 125,000 mPa·s at 25° C., alternatively from 200 mPa·s to 100,000 mPa·s at 25° C. alternatively from 200 mPa·s to 80,000 mPa·s measured at 25° C. relying on the cup/spindle method of ASTM D1084-16 Method B, using an appropriate spindle for the viscosity range unless otherwise indicated.

The organopolysiloxane polymer (i) may be selected from polydimethylsiloxanes, alkylmethylpolysiloxanes, alkylarylpolysiloxanes or copolymers thereof containing e.g. alkenyl and/or alkynyl groups and may have any suitable terminal groups, for example, they may be trialkyl terminated, alkenyldialkyl terminated or may be terminated with any other suitable terminal group combination providing each organopolysiloxane polymer (i) contains at least two unsaturated groups per molecule.

Hence the Organopolysiloxane polymer (i) may be, for the sake of example, dimethylvinyl terminated polydimethylsiloxane, dimethylvinyl terminated dimethylmethylphenylsiloxane, trialkyl terminated dimethylmethylvinyl polysiloxane or dialkylvinyl terminated dimethylmethylvinyl polysiloxane copolymers, although given the high level of alkenyl and/or alkynyl groups present such as vinyl groups trialkyl terminated dimethylmethylvinyl polysiloxane or dialkylvinyl terminated dimethylmethylvinyl polysiloxane copolymers may be preferred.

For example, an organopolysiloxane polymer (i) containing unsaturated groups selected from alkenyl groups and/or alkynyl groups at the two terminals may be represented by the general formula (II):

R′R″R′″SiO—(R″R′″SiO)ₘ—SiOR′″R″R′ (II)

In formula (II), each R′ may be an alkenyl group or an alkynyl group, which typically contains from 2 to 10 carbon atoms. Alkenyl groups include but are not limited to vinyl, propenyl, butenyl, pentenyl, hexenyl an alkenylated cyclohexyl group, heptenyl, octenyl, nonenyl, decenyl or similar linear and branched alkenyl groups and alkenylated aromatic ringed structures. Alkynyl groups may be selected from but are not limited to ethynyl, propynyl, butynyl, pentynyl, hexynyl, an alkynylated cyclohexyl group, heptynyl, octynyl, nonynyl, decynyl or similar linear and branched alkenyl groups and alkenylated aromatic ringed structures.

R″ does not contain ethylenic unsaturation, each R″ may be the same or different and is individually selected from monovalent saturated hydrocarbon group, which typically contain from 1 to 10 carbon atoms, and monovalent aromatic hydrocarbon group, which typically contain from 6 to 12 carbon atoms. R″ may be unsubstituted or substituted with one or more groups that do not interfere with curing of the silicone/polyurethane synthetic leather topcoat composition described herein, such as halogen atoms. R′″ is R′ or R″ and m is a whole number.

Component (i) of the silicone/polyurethane synthetic leather topcoat composition may comprise more than one organopolysiloxane polymer (i), having a viscosity of from 100 to 500,000 mPa·s at 25° C. When a mixture of organopolysiloxane polymers is used for component (i), at least one, alternatively one may comprise at least 5 wt. % of the polymer per molecule of unsaturated groups selected from alkenyl groups, alkynyl groups or a mixture thereof, alternatively from 5 to 15 wt. % of the polymer per molecule, alternatively from 6 to 15 wt. % of the polymer per molecule, alternatively from 7 to 15 wt. % of the polymer per molecule which may be determined using quantitative infra-red analysis in accordance with ASTM E168.

Component (i), is typically present in an amount of from 3 wt. %, alternatively from 10 wt. % of the composition, to 50 wt. %, alternatively 45 wt. % of the composition, for example organopolysiloxane polymer (i) may be present in a range of from 10 to 50 wt. %, alternatively from 10 to 45 wt. % of the composition.

### (ii) Reinforcing Filler

Component (ii) of the silicone/polyurethane synthetic leather topcoat composition is a reinforcing filler such as finely divided silica. Silica and other reinforcing fillers (ii) are often treated with one or more known hydrophobing filler treating agents to prevent a phenomenon referred to as “creping” or “crepe hardening” during processing of the silicone/polyurethane synthetic leather topcoat composition.

Finely divided forms of silica are preferred as reinforcing fillers (ii). Precipitated and/or fumed silicas, alternatively fumed silica is/are particularly preferred because of their relatively high surface area, which is typically at least 50 m²/g (BET method in accordance with ISO 9277: 2010). Fillers having surface areas of from 50 to 450 m²/g (BET method in accordance with ISO 9277: 2010), alternatively of from 50 to 300 m²/g (BET method in accordance with ISO 9277: 2010), are typically used. Both types of silica are commercially available.

The amount of reinforcing filler (ii) e.g. finely divided silica in the silicone/polyurethane synthetic leather topcoat composition herein is from 5 to 40 wt. %, alternatively of from 5 to 30 wt. %. In some instances, the amount of reinforcing filler may be of from 7.5 to 30 wt. %., alternatively from 10 to 30 wt. %. based on the weight of the composition, alternatively from 15 to 30 wt. %. based on the weight of the composition.

When reinforcing filler (ii) is naturally hydrophilic (e.g. untreated silica fillers), it is typically treated with a treating agent to render it hydrophobic. These surface modified reinforcing fillers (ii) do not clump and can be homogeneously incorporated into organopolysiloxane polymer (i) as the surface treatment makes the fillers easily wetted by organopolysiloxane polymer (i). This results in improved room temperature mechanical properties of the silicone/polyurethane synthetic leather topcoat composition s and resulting cured materials cured therefrom.

The surface treatment may be undertaken prior to introduction in the composition or in situ (i.e. in the presence of at least a portion of the other components of the composition herein by blending these components together at room temperature or above until the filler is completely treated. Typically, untreated reinforcing filler (ii) is treated in situ with a treating agent in the presence of organopolysiloxane polymer (i), whereafter mixing a silicone rubber base material is obtained, to which other components may be added.

Typically reinforcing filler (ii) may be surface treated with any low molecular weight organosilicon compounds disclosed in the art applicable to prevent creping of the silicone/polyurethane synthetic leather topcoat composition during processing. For example, organosilanes, organopolysiloxanes, or organosilazanes e.g. hexaalkyl disilazane, short chain siloxane diols or fatty acids or fatty acid esters such as stearates to render the filler(s) hydrophobic and therefore easier to handle and obtain a homogeneous mixture with the other components. Specific examples include, but are not restricted to, silanol terminated trifluoropropylmethyl siloxane, dimethyl silanol terminated vinylmethyl (ViMe) siloxane, tetramethyldi(trifluoropropyl)disilazane, tetramethyldivinyl disilazane, silanol terminated MePh siloxane, liquid hydroxyl-terminated polydiorganosiloxane containing an average from 2 to 20 repeating groups of diorganosiloxane in each molecule, hexaorganodisiloxane, hexaorganodisilazane. A small amount of water can be added together with the silica treating agent(s) as processing aid.

The filler may be introduced into the silicone/polyurethane synthetic leather topcoat composition in the form of a masterbatch or base comprising said filler and an organopolysiloxane polymer. The organopolysiloxane polymer used for the masterbatch or base may be of a similar structure to component (i) but alternatively may be an organopolysiloxane polymer having a viscosity in the same range as component (i) but having an alkenyl and/or alkynyl content of <5 wt. % of the polymer. If required, the fumed silica may be hydrophobically treated in situ during the preparation of the masterbatch by the introduction of suitable hydrophobing agents into the mixture.

The silicone/polyurethane synthetic leather topcoat composition as described herein is cured using a hydrosilylation cure package comprising an organohydrogenpolysiloxane having 3 or more silicon-bonded hydrogen atoms per molecule (Component iii) and a hydrosilylation catalyst (component iv).

(iii) Organohydrogenpolysiloxane

Component (iii) is a cross-linker in the form of a polyorganosiloxane containing at least two or alternatively at least three silicon bonded hydrogen (—Si—H) groups per molecule. Component (B) normally contains three or more —Si—H groups so that the hydrogen atoms can react with the unsaturated alkenyl or alkynyl groups of component (i) to form a network structure therewith and thereby cure the composition. Some or all of Component (iii) may alternatively have two —Si—H groups per molecule particularly when component (i) has greater than (>) two alkenyl or alkynyl groups per molecule.

The molecular configuration of the polyorganosiloxane containing at least two or three Si—H groups per molecule (B) is not specifically restricted, and it can be a straight chain, a straight chain with some branching, cyclic or silicone resin based.

Silicon-bonded organic groups used in component (iii) may be exemplified by methyl, ethyl, propyl, butenyl, pentenyl, hexyl, or similar alkyl groups; phenyl, tolyl, xylyl, or similar aryl groups; 3-chloropropyl, 3,3,3-trifluoropropyl, or similar halogenated alkyl group, preferable of which are methyl and phenyl groups.

Examples of the polyorganosiloxane containing at least two or three silicon bonded hydrogen groups per molecule (iii) include but are not limited to:
(a) branched and/or chain extended dimethylhydrogensiloxy-terminated polydimethylsiloxanes,
(b) dimethylhydrogensiloxy-terminated dimethylsiloxane-methylhydrogensiloxane copolymers,
(c) copolymers and/or silicon resins consisting of (CH₃)₂HSiO_{1/2} units, (CH₃)₃SiO_{1/2} units and SiO_{4/2} units,
(d) copolymers and/or silicone resins consisting of (CH₃)₂HSiO_{1/2} units and SiO_{4/2} units,
(e) copolymers and/or silicone resins consisting of (CH₃)₂HSiO_{1/2} units, SiO_{4/2} units and (C₆H₅)₃SiO_{1/2} units, and alternatives in which methyl is replaced by phenyl groups or other alkyl groups.
(f) silicone resins comprising or consisting of Si—H groups such as (CH₃)₂HSiO_{1/2} groups, (CH₃)₂SiO_{2/2} groups and SiO_{4/2} groups.
   The silicone resins mentioned above may also comprise T groups and/or D groups, alternatively T groups. Other potential cross-linkers (iii) may include
(g) 1,1,3,3-tetramethyldisiloxane,
(h) 1,3,5,7-tetramethylcyclotetrasiloxane,
(i) tris(hydrogendimethylsiloxy)methylsilane,
(j) tris(hydrogendimethylsiloxy)phenylsilane, methylhydrogencyclopolysiloxane,
(k) trimethylsiloxy-end-blocked methylhydrogenpolysiloxane,
(l) trimethylsiloxy-end-blocked dimethylsiloxane/methylhydrogensiloxane copolymers,
(m) dimethylhydrogensiloxy-end-blocked dimethylpolysiloxane,
(n) dimethylhydrogensiloxy-end-blocked dimethylsiloxane/methylhydrogensiloxane copolymers,
(o) trimethylsiloxy-end-blocked methylhydrogensiloxane/diphenylsiloxane copolymers,
(p) trimethylsiloxy-end-blocked methylhydrogensiloxane/diphenylsiloxane/-dimethylsiloxane copolymers,
(q) trimethylsiloxy-end-blocked methylhydrogensiloxane/methylphenylsiloxane/-dimethylsiloxane copolymers,
(r) dimethylhydrogensiloxy-end-blocked/dimethylsiloxane/-diphenylsiloxane copolymers and/or
(s) dimethylhydrogensiloxy-end-blocked methylhydrogensiloxane/dimethylsiloxane/-methylphenylsiloxane copolymers,
(t) Others include tetrakis(dimethylsiloxy)silane, hydride terminated, polyphenylmethyl siloxane hydride terminated, polyphenyl-(dimethylhydrosiloxy) siloxane, or phenyltris(dimethylsiloxy)silane or the like. Alternatively, component (ii), the cross-linker, may be a filler, e.g., silica treated with one of the above.

In one alternative the cross-linker may be a silicone resin comprising a mixture of Q, T, D and/or M groups having a viscosity of from 10 to 5000 mPa·s at 25° C., alternatively 10 to 1000 mPa·s at 25° C., alternatively 10 to 500 mPa·s at 25° C. such as (c), (d) and/or (e) as described above

The polyorganosiloxane containing at least two or three —Si—H groups per molecule (iii) is typically added in an amount such that the molar ratio of the silicon-bonded hydrogen atoms in component (iii) to that of all unsaturated groups in the composition is from 0.5:1 to 20:1; alternatively of from 0.5:1 to 5:1, alternatively from 0.6:1 to 3:1. When this ratio is less than 0.5:1, a well-cured composition will not be obtained. When the ratio exceeds 20:1, there is a tendency for the hardness of the cured composition to increase when heated.

The silicon-bonded hydrogen (Si—H) content of component (iii) is determined using quantitative infra-red analysis in accordance with ASTM E168. In the present instance the silicon-bonded hydrogen to alkenyl (vinyl) and/or alkynyl ratio is important when relying on a hydrosilylation cure process. Generally, this is determined by calculating the total weight % of alkenyl groups in the composition, e.g., vinyl [V] and the total weight % of silicon bonded hydrogen [H] in the composition and given the molecular weight of hydrogen is 1 and of vinyl is 27 the molar ratio of silicon bonded hydrogen to vinyl is 27[H]/[V].

While the molecular weight of this component is not specifically restricted, the viscosity is typically from 15 to 50,000 mPa·s at 25° C. relying on a Brookfield DV 3T Rheometer or using either a Brookfield® rotational viscometer with spindle LV-4 (designed for viscosities in the range between 1,000-2,000,000 mPa·s) or a Brookfield® rotational viscometer with spindle LV-1 (designed for viscosities in the range between 15-20,000 mPa·s) for viscosities less than 1000 mPa·s and adapting the speed according to the polymer viscosity.

Component (iii) of the silicone/polyurethane synthetic leather topcoat composition is a polyorganosiloxane containing at least two or alternatively at least three silicon bonded hydrogen (—Si—H) groups per molecule, which functions as a cross-linker for polymer (i), by the addition reaction of the silicon-bonded hydrogen atoms in component (iii) with the alkenyl groups and/or alkynyl groups in component (i) under the catalytic activity of component (iv) to be mentioned below. Component (iii) contains at least 5,000 parts per million (ppm) of silicon bonded hydrogen (Si—H), alternatively at least 7000 ppm, alternatively from 7000 to 12,000 ppm of silicon bonded hydrogen, alternatively 8000 ppm to 11,000 ppm of silicon bonded hydrogen so that the silicon bonded hydrogen atoms of this component can sufficiently react with the alkenyl groups and/or alkynyl groups, typically alkenyl groups, especially vinyl groups of component (i) to form a network structure therewith and thereby cure the composition. The quantity of silicon bonded hydrogen present is also determined using quantitative infra-red analysis in accordance with ASTM E168.

Component (iii) is typically present in the total composition in an amount of from 5 to 30 wt. %, 5 to 20 wt. %, alternatively from 10 to 20 wt. % of the composition but the amount present is typically determined by the molar ratio of the silicon-bonded hydrogen atoms in component (iii) to the total number of all unsaturated groups, e.g. alkenyl and alkynyl groups, often vinyl groups as described above.

### iv) Hydrosilvlation Catalyst

The silicone/polyurethane synthetic leather topcoat composition is cured via a hydrosilylation (addition) reaction catalysed by a hydrosilylation (addition cure) catalyst (iv) that is a metal selected from the platinum metals group, i.e. platinum, ruthenium, osmium, rhodium, iridium and palladium, or a compound of such metals. Platinum and rhodium compounds are preferred due to the high activity level of these catalysts for hydrosilylation reactions.

The catalyst (iv) can be a platinum group metal, a platinum group metal deposited on a carrier, such as activated carbon, metal oxides, such as aluminum oxide or silicon dioxide, silica gel or powdered charcoal, or a compound or complex of a platinum group metal.

Examples of preferred hydrosilylation catalysts (iv) are platinum based catalysts, for example, platinum black, platinum oxide (Adams catalyst), platinum on various solid supports, chloroplatinic acids, alcohol solutions of chloroplatinic acid, and complexes of chloroplatinic acid with ethylenically unsaturated compounds such as olefins and organosiloxanes containing ethylenically unsaturated silicon-bonded hydrocarbon groups. Soluble platinum compounds that can be used include, for example, the platinum-olefin complexes of the formulae (PtCl₂·(olefin)₂ and H(PtCl₃·olefin), preference being given in this context to the use of alkenes having 2 to 8 carbon atoms, such as ethylene, propylene, isomers of butene and of octene, or cycloalkanes having five to seven carbon atoms, such as cyclopentene, cyclohexene, and cycloheptene. Other soluble platinum catalysts are, for the sake of example a platinum-cyclopropane complex of the formula (PtCl₂C₃H₆)₂, the reaction products of hexachloroplatinic acid with alcohols, ethers, and aldehydes or mixtures thereof, or the reaction product of hexachloroplatinic acid with methylvinylcyclotetrasiloxane in the presence of sodium bicarbonate in ethanolic solution. Platinum catalysts with phosphorus, sulfur, and amine ligands can be used as well, e.g., (Ph₃P)₂PtCl₂; and complexes of platinum with vinylsiloxanes, such as sym-divinyltetramethyldisiloxane.

Hence, specific examples of suitable platinum-based catalysts include
(i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum in a solvent, such as toluene may be used. These are described in U.S. Pat. Nos. 3,715,334 and 3,814,730.

The hydrosilylation catalyst (iv) of silicone/polyurethane synthetic leather topcoat composition is present in the total composition in a catalytic amount, i.e., an amount or quantity sufficient to catalyse the addition/hydrosilylation reaction and cure the composition to an elastomeric material under the desired conditions. Varying levels of the hydrosilylation catalyst (iv) can be used to tailor reaction rate and cure kinetics. The catalytic amount of the hydrosilylation catalyst (iv) is generally between 0.01 ppm, and 10,000 parts by weight of platinum-group metal, per million parts (ppm), based on the weight of the composition; alternatively, between 0.01 and 5000 ppm; alternatively, between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst package is provided the amount of catalyst present will be within the range of from 0.001 to 3.0 wt. % of the composition alternatively, from 0.1 to 3.0 wt. % of the composition, alternatively from 0.1 to 2.0 wt. % of the composition, alternatively from 0.1 to 1.5 wt. % of the composition.

### Component (v) Adhesion Promoter

Component (v) is an adhesion promoter for adhering the silicone/polyurethane synthetic leather topcoat composition to its adjacent polyurethane layer of the silicone/polyurethane synthetic leather, e.g. a polyurethane skin layer, comprising a combination of zirconium acetylacetonate in an amount of from 1 to 5 wt. % of the composition with 1,3,5-tris[3-(trimethoxysilyl)propyl]-1,3,5-triazine-2,4,6(1H,3H,5H)-trione of the following structure

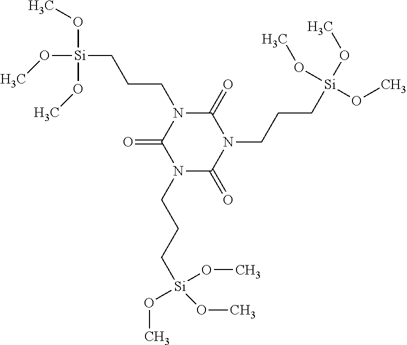

and/or one or more epoxy silanes of the formula

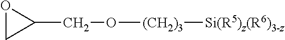

wherein each R⁵ is the same or different and is an alkyl group having 1 to 6 carbons, each R⁶ is the same or different and is an alkoxy group having 1 to 6 carbons and z=0, 1 or 2, or a mixture thereof, in an amount of from 1 to 6 wt. % of the composition. Alternatively, each R⁵ is an alkyl group having 1 to 3 carbons, alternatively having 1 to 2 carbons. Alternatively, each R⁶ is an alkoxy group having 1 to 3 carbons, alternatively having 1 to 2 carbons. Preferably z is 0 or 1, alternatively z is 0. In one embodiment said epoxysilane is selected from 3-glycidoxypropyltrimethoxysilane, 3-glycidoxypropyltriethoxysilane, 3-glycidoxypropylmethyldiethoxysilane and/or 3-glycidoxypropylmethyldimethoxysilane.

It is believed, without being bound by current theories, that such adhesion promoters accelerate the hydrolysis and condensation of silanes thereby causing them to react with hydroxyl groups from the adjacent polyurethane layer onto which the present silicone/polyurethane synthetic leather topcoat composition is applied.

Component (vi)—Eco-Solvent

Component (vi) of the silicone/polyurethane synthetic leather topcoat composition is an eco-solvent. Any suitable eco-solvent may be utilised, examples include isopentadecane, isohexadecane, isoheptadecane, isooctadecane, isononadecane and mixtures thereof or trimethyl terminated polydimethylsiloxane having a viscosity of from greater than or equal to (≥)5 mPa·s at 25° C. to less than or equal to (≤) 100 mPa·s at 25° C. It has been noted that use of a trimethyl terminated polydimethylsiloxane having a viscosity of <5 mPa·s at 25° C. seems to result in a leather material which in fact does whiten in its stretch marks. In one embodiment the eco-solvent comprises or consists of isohexadecane. The eco-solvent is present in the composition as a means of diluting the composition and is present in the composition in an amount of from 30 to 70 wt. % of the composition. It may be present in either part or in both parts A and B, as desired or required.

Component (vii) Optional Cured Silicone Elastomer Powder

When required any suitable cured silicone elastomer powder may be utilised in the silicone/polyurethane synthetic leather topcoat composition. In one alternative, cured silicone elastomer powder (vii) has an average particle size of from 0.01 to 100 μm, alternatively 0.01 to 50 μm, alternatively from 0.01 to 25 μm. They may contain chemically functional groups, e.g. epoxy groups (meth)acryloxy groups or may be coated e.g. with a silica treated coating.

The cured silicone elastomer powder is made from a suitable curable silicone composition. These may include, for example, addition (hydrosilylation) reaction-curing silicone compositions, condensation reaction-curing silicone compositions, organoperoxide-curing silicone compositions, and ultraviolet-curing silicone compositions. Addition reaction-curing and condensation reaction-curing silicone compositions are preferred for their ease of handling.

Silicone elastomer powders are generally prepared by making a homogeneous water-based emulsion of the curable silicone composition by first dispersing the curable silicone composition in water or an aqueous surfactant solution, and by then subjecting this dispersion to the action of an agitator such as a homogenizer, colloid mill, or a nixing device such as an ultrasonic vibrator. The water-based curable silicone emulsion is preferably prepared using surfactant to obtain a very stable emulsion in which the curable silicone composition has a small average particle diameter. A water-based dispersion of the cured silicone powder is then produced by curing the curable silicone present in the water-based emulsion. This cure may be affected by allowing said water-based emulsion to stand at room temperature or by heating the water-based emulsion. If heating the water-based curable silicone emulsion, the preferred heating temperature should not exceed 100° C., while particularly preferred temperatures fall in the range of 40° C. to 95° C. The techniques for heating the water-based curable silicone emulsion are by direct heating of the water-based emulsion or by adding the water-based emulsion to hot water. Commercial examples which may be utilised as component (vii) include, for the sake of example, Dowsil™ 23N, Dowsil™ 603T additive and Dowsil™ 9701 Cosmetic Powder from Dow Silicones Corporation.

The cured silicone rubber powder is present in the silicone/polyurethane synthetic leather topcoat composition in an amount of from 2.5 to 20 wt. % of the composition, alternatively from 2.5 to 15 wt. % of the composition, alternatively from 2.5. to 10 wt. % of the composition, i.e. when part A and part B are mixed together.

### Optional Additives

The silicone/polyurethane synthetic leather topcoat composition may comprise one or more additives. Examples of these optional additives include cure inhibitors, inorganic non-reinforcing fillers, electrically conductive additives, pot life extenders, lubricants, flame retardants, pigments, colouring agents, chain extenders, heat stabilizers, compression set improvement additives, antisqueak agents, antioxidants, antistatic agents, anti-soiling agents and light stabilizers, anti-freeze agents and/or biocides and mixtures thereof.

### Inhibitor

Optionally, to obtain a longer working time or pot life of the silicone/polyurethane synthetic leather topcoat composition because a hydrosilylation cure system is being utilised, a suitable inhibitor may be incorporated into the composition in order to retard or suppress the activity of the catalyst.

Inhibitors of platinum metal-based catalysts, generally a platinum metal-based catalyst is well known in the art. Hydrosilylation or addition-reaction inhibitors include hydrazines, triazoles, phosphines, mercaptans, organic nitrogen compounds, acetylenic alcohols, silylated acetylenic alcohols such as methyl (tris(1,1-dimethyl-2-propynyloxy))silane, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines. Alkenyl-substituted siloxanes as described in U.S. Pat. No. 3,989,667 may be used, of which cyclic methylvinylsiloxanes are preferred.

Another class of known inhibitors of platinum catalysts includes the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Hydrosilylation curable silicone elastomer compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargyl alcohol, 3,5-dimethyl-1-hexyn-3-ol, 1-ethynylcyclopentanol, 1-phenyl-2-propynol, 3-methyl-1-penten-4-yn-3-ol, and mixtures thereof.

When present, inhibitor concentrations as low as 1 mole of inhibitor per mole of the metal of catalyst (iv) will in some instances impart satisfactory storage stability and cure rate. In other instances, inhibitor concentrations of up to 500 moles of inhibitor per mole of the metal of catalyst (iv) are required. The optimum concentration for a given inhibitor in a given composition is readily determined by routine experimentation. Dependent on the concentration and form in which the inhibitor selected is provided/available commercially, when present in the composition, the inhibitor is typically present in an amount of from 0.0125 to 10 wt. % of the composition. Mixtures of the above may also be used.

### Inorganic Non-Reinforcing Filler

Inorganic non-reinforcing fillers, when present, in the silicone/polyurethane synthetic leather topcoat composition, may comprise crushed quartz, diatomaceous earths, barium sulphate, iron oxide, titanium dioxide and carbon black, wollastonite and platelet type fillers such as, graphite, graphene, talc, mica, clay, sheet silicates, kaolin, montmorillonite and mixtures thereof. Other inorganic non-reinforcing fillers which might be used alone or in addition to the above include aluminite, calcium sulphate (anhydrite), gypsum, calcium sulphate, magnesium carbonate, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite.

Inorganic non-reinforcing fillers when present may alternatively or additionally be selected from aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃·2SiO₂; kyanite; and Al₂SiO₅. The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

Suitable sheet silicates e.g. silicate minerals which may be utilised include but are not limited to mica; K₂AI₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite. When present, the non-reinforcing filler(s) is/are present up to a cumulative total of from 1 to 50 wt. %. of the composition.

Whenever deemed necessary the non-reinforcing filler may also be treated as described above with respect to the reinforcing fillers (ii) to render them hydrophobic and thereby easier to handle and obtain a homogeneous mixture with the other components. As in the case of the reinforcing fillers (ii) surface treatment of the non-reinforcing fillers makes them easily wetted by organopolysiloxane polymer (i) which may result in improved properties of the silicone/polyurethane synthetic leather topcoat compositions, such as better processability (e.g. lower viscosity, better mold releasing ability and/or less adhesive to processing equipment, such as two roll mill), heat resistance, and mechanical properties.

Any suitable antioxidants, antistatic agents, anti-soiling agents and/or light stabilizers may be utilised in the composition.

Preferably the electrically conductive additives which may be used herein are inorganic. Examples of electrically conductive additives which may be present in the silicone/polyurethane synthetic leather topcoat composition include metal particles, metal oxide particles, metal-coated metallic particles (such as silver-plated nickel), metal coated non-metallic core particles (such as silver coated talc, or mica or quartz) and a combination thereof. Metal particles may be in the form of powder, flakes or filaments, and mixtures or derivatives thereof.

Pot life extenders, such as triazole, may be used, but are not considered necessary in the scope of the present invention. The silicone/polyurethane synthetic leather topcoat composition may thus be free of pot life extender.

In the case of lubricants, the lubricants may be reactive with other ingredients of the composition or unreactive therewith. They may include organopolysiloxanes having an analogous basic structure to that of component (i) but only having one unsaturated group e.g. one alkenyl group per molecule. Alternatively, the lubricant may be an organic wax or the like. When reactive the wax may for example be alkenylated wax having from 15 to 30 carbons per molecule, alternatively having from 15 to 30 carbons per molecule with at least one alkenylated group e.g. a vinyl group per molecule.

Unreactive lubricants may be present in the composition if desired these may include but are not limited to boron nitride, graphite, molybdenum sulfide and the like, or mixtures thereof.

Examples of flame retardants include aluminium trihydrate, magnesium hydroxide, calcium carbonate, zinc borate, wollastonite, mica and chlorinated paraffins, hexabromocyclododecane, triphenyl phosphate, dimethyl methylphosphonate, tris(2,3-dibromopropyl) phosphate (brominated tris), and mixtures or derivatives thereof.

Examples of pigments include carbon black, iron oxides, titanium dioxide, chromium oxide, bismuth vanadium oxide and mixtures or derivatives thereof.

Examples of colouring agents include vat dyes, reactive dyes, acid dyes, chrome dyes, disperse dyes, cationic dyes and mixtures thereof.

Where the optional additives may be used for more than one reason e.g. as a non-reinforcing filler and flame retardant, when present they may function in both roles. When or if present, the aforementioned additional components are cumulatively present in an amount of from 0.1 to 30 wt. %, alternatively of from 0.1 to 20 wt. % of the composition.

In order to prevent premature cure in storage, the silicone/polyurethane synthetic leather topcoat composition will be stored prior to use in two-parts Part A and part B. Typically, part A will contain some of organopolysiloxane polymer (i) and reinforcing filler (ii) and hydrosilylation catalyst (iv) and part B will contain the remainder of organopolysiloxane polymer (i) and reinforcing filler (ii) together with organohydrogenpolysiloxane (iii) and, usually if present, the inhibitor, but this can vary dependent on the choice of the inhibitor used. The two-part composition may be designed to be mixed together in any suitable ratio, dependent on the amounts of organopolysiloxane polymer (i) and reinforcing filler (ii) in part B and as such can be mixed in a Part A:Part B weight ratio of from 15:1 to 1:2, but are preferably mixed in a Part A:Part B weight ratio of from 2:1 to 1:2, alternatively from 1.5:1 to 1:1.5, alternatively 1:1.

Optional additives may be introduced into the silicone/polyurethane synthetic leather topcoat composition in either Part A or part B as required providing they do not cause a negative effect on any of the other ingredients in that respective part.

The individual parts of the silicone/polyurethane synthetic leather topcoat composition may be prepared in any way suitable. Any mixing techniques and devices described in the prior art can be used for this purpose. The particular device to be used will be determined dependent on the viscosities of components and the final curable silicone/polyurethane synthetic leather topcoat composition. Suitable mixers include but are not limited to paddle type mixers e.g. planetary mixers and kneader type mixers. Cooling of components during mixing may be desirable to avoid premature curing of the composition.

As previously discussed, component (ii) the reinforcing filler may be introduced into the silicone/polyurethane synthetic leather topcoat composition in the form of a filler (e.g. fumed silica) masterbatch used to introduce e.g. fumed silica into both part A or Part B of the composition. Such a masterbatch may comprise from 25 to 45 wt. % of fumed silica and from 55 to 75 wt. % of organopolysiloxane containing at least 2 alkenyl and/or alkynyl groups per molecule. The organopolysiloxane may be component (i) above and/or an organopolysiloxane in the same viscosity range as component (i) but having an alternative alkenyl and/or alkynyl content. In one embodiment the organopolysiloxane containing at least 2 alkenyl and/or alkynyl groups per molecule in the fumed silica masterbatch is a dimethylvinyl terminated polydimethylsiloxane having a viscosity of between 30,000 and 80,000 mPa·s at 25° C. and a vinyl content of from 0.05 to 0.2 wt. % of the polymer, alternatively a vinyl content of from 0.05 to 0.15 wt. % of the polymer determined using quantitative infra-red analysis in accordance with ASTM E168. Such a masterbatch may comprise just the fumed silica and polymer but may optionally also contain small amounts of other ingredients such as hexamethyldisilazane (HMDZ), divinyltetramethyldisiloxane, dimethylhydroxy terminated methylvinyl siloxane polymer having a viscosity of 10 to 100 mPa·s and a vinyl content of 5 to 20 wt. %, alternatively 7.5 to 15 wt. % of said polymer (determined using quantitative infra-red analysis in accordance with ASTM E168); and/or water.

Hence, when Part A and Part B are mixed together the silicone/polyurethane synthetic leather topcoat composition may comprise: Component (i) one or more organopolysiloxane polymer(s) having a viscosity of from 100 mPa·s to 500,000 mPa·s at 25° C., alternatively 200 mPa·s to 150,000 mPa·s at 25° C., alternatively from 200 mPa·s to 125,000 mPa·s at 25° C., alternatively from 200 mPa·s to 100,000 mPa·s at 25° C. alternatively from 200 mPa·s to 80,000 mPa·s measured at 25° C. with at least 2 unsaturated groups per molecule, in an amount of from 3, alternatively from 10 wt. % of the composition, to 50 wt. %, alternatively 45 wt. % of the composition, for example organopolysiloxane polymer (i) may be present in a range of from 10 to 50 wt. %, alternatively from 10 to 45 wt. % of the composition. Component (ii) a reinforcing filler, i.e. a fumed silica which is preferably hydrophobically treated which may be introduced directly into the composition or may be introduced in the form of a masterbatch; wherein the BET surface area of are generally at least 50 m²/g (BET method in accordance with ISO 9277: 2010). Fillers having surface areas of from 50 to 450 m²/g (BET method in accordance with ISO 9277: 2010), alternatively of from 50 to 300 m²/g with amount of reinforcing filler (ii) e.g. finely divided silica in the hydrosilylation curable silicone elastomer composition herein is from 5 to 40 wt. %, alternatively of from 5 to 30 wt. %. In some instances, the amount of reinforcing filler may be of from 7.5 to 30 wt. %., alternatively from 10 to 30 wt. %. of the composition, alternatively from 15 to 30 wt. %. of the composition; when in the form of a masterbatch, the masterbatch may comprise from 25 to 45 wt. % of fumed silica and from 55 to 75 wt. % of component (i) and/or a dimethylvinyl terminated polydimethylsiloxane having a viscosity of between 50,000 and 80,000 mPa·s at 25° C. and a vinyl content of from 0.05 to 0.2 wt. % of the polymer, alternatively a vinyl content of from 0.05 to 0.15 wt. % of the polymer; alternatively 55 to 75 wt. % of a dimethylvinyl terminated polydimethylsiloxane as described above; The masterbatch composition may also initially include treating agents for the in situ treating of the filler to render it hydrophobic and therefore easier to mix with the polymer; Component (iii) a polyorganosiloxane containing at least two or alternatively at least three silicon bonded hydrogen (—Si—H) groups per present in the total composition in an amount of from 5 to 30 wt. %, 5 to 20 wt. %, alternatively from 10 to 20 wt. % of the composition but the amount present is typically determined by the molar ratio of the silicon-bonded hydrogen atoms in component (iii) to the total number of all unsaturated groups which is from 0.5:1 to 20:1, alternatively from 0.5:1 to 10:1, alternatively from 0.5:1 to 5:1, alternatively from 1:1 to 5:1 preferably with Si—H being in excess; the viscosity of component (iii) is from 15 to 50 mPa·s at 25° C., alternatively from 15 to 40 mPa·s at 25° C., alternatively from 20 to 35 mPa·s at 25° C.; Component (iv) a hydrosilylation catalyst composition provided the amount of catalyst present will be within the range of from 0.01 to 3.0 wt. % of the composition, alternatively, from 0.1 to 3.0 wt. % of the composition, alternatively from 0.1 to 2.0 wt. % of the composition, alternatively from 0.1 to 1.5 wt. % of the composition and containing from between 0.01 ppm, and 10,000 parts by weight of platinum-group metal, per million parts (ppm), based on the combined weight of the components (i) and (ii); alternatively, between 0.01 and 7500 ppm; alternatively, between 0.01 and 3,000 ppm, and alternatively between 100 and 6,000 ppm;

Component (v) an adhesion promoter comprising a combination of zirconium acetylacetonate in an amount of from 1 to 5 wt. % of the composition with 1,3,5-tris[3-(trimethoxysilyl)propyl]-1,3,5-triazine-2,4,6(1H,3H,5H)-trione, and/or one or more epoxy silanes of the formula

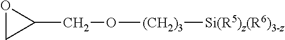

wherein R⁵ is an alkyl group having 1 to 6 carbons, R⁶ is an alkoxy group having 1 to 6 carbons and z=0, 1 or 2, or a mixture thereof, in an amount of from 1 to 6 wt. % of the composition; Component (vi) is an eco-solvent. Any suitable eco-solvent may be utilised, examples include isopentadecane, isohexadecane, isoheptadecane, isooctadecane, isononadecane and mixtures thereof or trimethyl terminated polydimethylsiloxane having a viscosity of from greater than or equal to (≥) 5 mPa·s at 25° C. to less than or equal to (≤) 100 mPa·s at 25° C. The eco-solvent is present in the composition as a means of diluting the composition and is present in an amount of from 30 to 70 wt. % of the composition, and optionally Component (vii) cured silicone elastomer powder has an average particle size of from 0.01 to 100 μm, alternatively 0.01 to 50 μm, alternatively from 0.01 to 25 μm. They may contain chemically functional groups, e.g. epoxy groups (meth)acryloxy groups or may be coated e.g. with a silica treated coating. When present, the cured silicone rubber powder is present in the composition in an amount of from 2.5 to 20 wt. % of the composition, alternatively from 2.5 to 15 wt. % of the composition, alternatively from 2.5. to 10 wt. % of the composition, i.e. when part A and part B are mixed together.

The total wt. % of the composition including components (i) to (vii) and any additives is 100 wt. % but may be any suitable combination of the above.

The order for mixing components in the hydrosilylation curable silicone elastomer composition of the silicone/polyurethane synthetic leather topcoat composition is not critical. Suitable parts A and B are prepared and then part A and part B are mixed together in a predetermined weight ratio between 15:1 and 1:2 e.g., for the sake of example, a 1:1 ratio shortly prior to use.

Curing of the silicone/polyurethane synthetic leather topcoat composition may be carried out at a suitable temperature for hydrosilylation cure. For example, a cure temperature of from about 80° C. to 180° C., alternatively from 80° C. to 150° C., alternatively of from 120° C. to 150° C. It is imperative that the cure temperature of the silicone/polyurethane synthetic leather topcoat composition as described does not negatively affect the other layers of the silicone/polyurethane composite synthetic leather material.

The silicone/polyurethane synthetic leather topcoat composition as described is utilised as a topcoat for a silicone/polyurethane composite synthetic leather material because once cured it provides outstanding adhesion to an adjacent polyurethane layer has excellent stain resistance, i.e. it is easy to clean and shows good scratch resistance as shown in the following examples. The silicone/polyurethane synthetic leather topcoat composition may also be applied to various other types of leather, for example conventional leather, nubuck or suede but is specifically designed for use with polyurethanes.

The silicone/polyurethane synthetic leather topcoat composition maybe provided via an assortment of methods as discussed below but may be e.g. coated onto a suitable polyurethane based composite material in the last step of a preparation process to make a silicone/polyurethane composite synthetic leather material. In such a case the silicone/polyurethane composite synthetic leather material may be of any suitable combination of suitable layers with the silicone/polyurethane synthetic leather topcoat composition applied to form a silicone topcoat adhered thereon once cured.

By suitable polyurethane (PU) we mean an alternating copolymer generally prepared by reacting di or tri-isocyanates and a suitable polyol such as, for the sake of example, an alkylene polyol, a polyether polyol, a polyester polyol, or a polycarbonate polyol. The respective isocyanate and polyol, polymerise through the formation of carbamate/urethane links. They do not include polyureas or mixture with polyureas.

The silicone/polyurethane composite synthetic leather material may comprise several, e.g. 2, 3 or 4 different composite layers with the cured product of the silicone/polyurethane synthetic leather topcoat composition functioning as a topcoat. For example, the silicone/polyurethane composite synthetic leather material may therefore comprise from bottom to top:
(a) a textile support layer;
(b) a sponge/adhesive layer adhered to (a); the sponge layer may typically be made from polyurethane, but any other suitable sponge or adhesive material may be utilised if desired
(c) a suitable polyurethane “skin layer” adhered to sponge/adhesive layer (b); and finally
(d) the cured product of the silicone/polyurethane synthetic leather topcoat composition being provided on top of the suitable polyurethane skin layer as a topcoat.
   Wherein layer (b) is substantially sandwiched between layers (a) and (c) and layer (c) is substantially sandwiched between layers (b) and (d).

For the avoidance of doubt, layer (b) is substantially sandwiched between layers (a) and (c) and layer (c) is substantially sandwiched between layers (b) and the cured product of the silicone/polyurethane synthetic leather topcoat composition (d). By “substantially” we mean that there are four distinct layers but there may be intermixing between layers at the interface between respective layers.

The textile support layer may be made from any suitable textile material for example woven, knitted or non-woven textiles made from synthetic resin fibers, natural fibers and/or, microfibers. These may include but are not restricted to polyester fiber, a viscose rayon fiber, a polyamide fiber, nylon, an acrylic fiber, a polyolefin fiber; cellulose fibers such as cotton; and elastic textile materials, such as spandex, may be used as may mixtures of any two or more of the above. The textile support layer is designed to enhance mechanical strength of the silicone/polyurethane composite synthetic leather material.

Furthermore, any suitable sponge layer/adhesion layer may be utilised as component (b) in the above but typically the sponge layer/adhesion layer is at least partially made from a polyurethane material. The sponge layer/adhesion layer may be of any desired dry film thickness, for example from 50 μm to 1 mm thick, alternatively 150 μm to 1 mm, alternatively 250 μm to 1 mm thick, alternatively from 300 μm to 1 mm thick. It is typically dried after application at any suitable temperature, for example at 125 to 180° C., alternatively 125 to 170° C., alternatively 130 to 160° C. for a suitable period of up to 20 minutes, alternatively 1 to 10 minutes, alternatively for a period of from 1.5 minutes to 10 minutes, alternatively 2 minutes to 10 minutes. However, the preferred method to adhere the sponge layer/adhesion layer to the textile support layer is by means of lamination. Typically, such lamination step may take place as part of the above drying process, with lamination commencing when the sponge layer/adhesion layer has partially dried or alternatively when wet prior to commencement of the drying step, although the former is preferred.

Likewise any suitable polyurethane skin layer may be utilised. The polyurethane skin layer is designed as a protective synthetic layer. The polyurethane skin layer may be of any suitable dry film thickness, for example, 25 μm to 500 μm thick, alternatively 25 μm to 300 μm, alternatively 25 to 250 μm, alternatively 50 to 200 μm thick. It can be dried at any suitable temperature, for example at 50 to 175° C., alternatively 75 to 175° C., alternatively 75 to 150° C. alternatively 75 to 140° C. for a period of from 30 seconds to 5 minutes, alternatively 30 seconds to 4 minutes, alternatively 1 minute to 4 minutes, alternatively 1 minute to 3 minutes.

The PU skin layer may be activated using a suitable activation method if desired e.g. by plasma treatment, corona discharge treatment, UV-C/ozone or Vacuum-UV irradiation before application of the silicone/polyurethane synthetic leather topcoat composition.

A silicone/polyurethane composite synthetic leather material may therefore be prepared by providing a textile support as a textile support layer, applying a suitable layer of polyurethane on to the textile support layer drying the polyurethane layer and then applying a silicone/polyurethane synthetic leather topcoat composition as described herein onto the polyurethane layer.

Alternatively, a silicone/polyurethane composite synthetic leather material may be prepared as follows:

Taking a textile support layer (a), applying a sponge layer (b) onto the textile support layer (a), curing/drying/laminating as required the sponge layer (b); applying a polyurethane skin layer (c) on the surface of the sponge layer (b) remote from the textile support (a) drying the skin layer (c), applying a silicone/polyurethane synthetic leather topcoat composition as described herein onto the surface of the polyurethane skin layer and curing said silicone/polyurethane synthetic leather topcoat composition.

Alternatively, the above process may be undertaken in reverse, using a release liner as a temporary support prior to use. In this instance the process may be continuous or may be in two parts. In the two part process a polyurethane skin layer (c) is applied onto a release liner using any suitable means and is then dried, applying a sponge/adhesion layer (b) onto skin layer (c) and applying a textile support layer (a) on the side of the sponge layer (b) remote from the skin layer (c) by lamination commencing prior to drying sponge/adhesion layer (b) or after same has been partially dried. In such a case the partially prepared silicone/polyurethane composite synthetic leather material and stored and then can be separately treated with silicone/polyurethane synthetic leather topcoat composition. In such a case the release liner is removed, if desired the dried polyurethane skin layer (c) may be activated by e.g. corona discharge or the like and the silicone/polyurethane synthetic leather topcoat composition (d) is applied onto dried skin layer (c) and cured.

In the alternate continuous process the above process is repeated with the exception that silicone/polyurethane synthetic leather topcoat composition (d) is applied direct onto the release liner and cured and then skin layer (c) is applied onto the cured silicone/polyurethane synthetic leather topcoat composition (d) after which the process continues as depicted above.

The release liner is provided to protect the external surface of the silicone/polyurethane composite synthetic leather material after the silicone/polyurethane synthetic leather topcoat composition has been applied and cured or to protect the skin layer in the case of the two part process until it is desired to apply said silicone/polyurethane synthetic leather topcoat composition.

Irrespective of the above method utilised, the silicone/polyurethane synthetic leather topcoat composition is applied and cured to give a dry film thickness of about 2 to 50 μm, alternatively 5 to 30 μm alternatively 10 to 30 μm. It can be cured at any suitable temperature, for example at about 80° C. to 180° C., alternatively from 80° C. to 160° C., alternatively of from 80° C. to 130° C. for a period of from for a suitable period, e.g. between 30 seconds and 15 minutes, alternatively 30 seconds to 7.5 minutes, alternatively 30 seconds to 5 minutes, alternatively 1 to 2.5 minutes. It is important to ensure that the temperature of cure of the silicone/polyurethane synthetic leather topcoat composition as hereinbefore described does not negatively affect the other layers of the silicone/polyurethane composite synthetic leather material.

If desired the silicone/polyurethane composite synthetic leather material may be post cured at a temperature between about 75° C. and 180° C., generally but not necessarily if desired towards the lower end of the range e.g. from 75 to 120° C. for from 2 to 48 hours, alternatively from 6 to 36 hours, alternatively from 10 to 24 hours.

Each of layers (b), (c) and (d) above may be applied using any suitable method of application e.g. spraying, rolling, brushing, spin coating, dip coating, solvent casting, slot die coating, spray coating, knife coating, or gravure coating.

Any suitable release liner may be used for example super matting release paper ARX175DM from the Japan Asahi company. Any suitable release liner may be used for example super matting release paper ARX175DM from the Japan Asahi company release paper DE-7, DE-90, DE-43C, DE-73J from the Japan Dai Nippon Printing Co., Ltd or semi-matting release paper DE-73M also from the Japan Dai Nippon Printing Co., Ltd. Each cure step may take place in a suitable oven, e.g. by curing and drying in a hot-air oven or may be undertaken in a conveyor oven in the case of a continuous process.

The above processes depict the preparation of examples of silicone/polyurethane composite synthetic leather materials. The reader may appreciate that should the need arise additional layers may be introduced into the material if desired.

The silicone/polyurethane composite synthetic leather material may be designed to have a wide variety of properties given the content of the different layers, e.g. they may have excellent flame retardancy, smoke density, heat resistance, contamination resistance, solvent resistance, hydrolysis resistance, and the like as required for the end use of the leather. End uses envisaged include but are not limited to furniture, decoration, handbags, luggage, garments, footwear, car interiors, car seats, medical beds/seats and the like.

### EXAMPLES

In the following examples the hydrosilylation curable silicone elastomer composition which forms the silicone/polyurethane synthetic leather topcoat composition and several comparatives are tested to show the advantage the coating herein described with respect to maintaining gloss after abrasion. All viscosities are measured at 25° C. relying on the cup/spindle method of ASTM D1084-16 Method B, using an appropriate spindle for the viscosity range unless otherwise indicated. Alkenyl and/or alkynyl content and Si—H content were all determined using quantitative infra-red analysis in accordance with ASTM E168.

The ingredients used in the silicone/polyurethane synthetic leather topcoat composition used together with the names given in the following Tables/examples are defined below:
Vinyl-terminated siloxane polymer is Dimethylvinyl terminated polydimethylsiloxane having a viscosity of 65,000 mPa·s at 25° C. having a vinyl content of about 0.08 wt. %;
High vinyl siloxane copolymer is a dimethylvinyl terminated dimethylmethylvinyl polysiloxane copolymer having a viscosity of 15,000 mPa·s at 25° C. and a vinyl content of about 8.0 wt. %;
Vinyl-terminated siloxane copolymer 2 is a dimethylvinyl terminated dimethylmethylvinyl polysiloxane copolymer having a viscosity of 300 mPa·s at 25° C. and a vinyl content of about 1.15 wt. %;
Fumed silica is HDK® T30P pyrogenic silica (Wacker Chimie) having a BET surface area of 300 m²/g;
HMDZ is hexamethyldisilazane;
MVD (Methylvinyl diol) is a Dimethylhydroxy terminated polydimethylmethylvinylsiloxane having a viscosity of about 30 mPa·s at 25° C. and a vinyl content of about 12.0 wt. %;
Platinum catalyst is a platinum catalyst in a solution of polydimethylsiloxane having about 5000 ppm of platinum metal with respect to the rest of the composition;
Inhibitor is Methyl(tris(1,1-dimethyl-2-propynyloxy))silane;
Silicone elastomer powder is Dowsil® 23N (Dow Silicones Corporation);
Trimethyl terminated SiH cross linker is a trimethyl terminated dimethylmethylhydrogen polyorganosiloxane co-polymer having a viscosity of about 45 mPa·s at 25° C. and a silicon bonded hydrogen content of about 7220 ppm;
Resinous SiH crosslinker is Si—H dimethyl terminated resinous Si—H polysiloxane having a viscosity of 25 mPa·s at 25° C. and a silicon bonded hydrogen content of about 9,000 ppm;
ZrAcAc Masterbatch is zirconium acetylacetonate in a 50:50 masterbatch of Vinyl-terminated
siloxane polymer
Silane 1 is 3-Glycidoxypropyltrimethoxysilane
Silane 2 is 1,3,5-tris[3-(trimethoxysilyl)propyl]-1,3,5-triazine-2,4,6(1H,3H,5H)-trione
Silane 3 is Bis(trimethoxysilyl)hexane

Table 1 provides details of the starting materials used for the silica masterbatch in the composition described below. The fumed silica was mixed with the Vinyl-terminated siloxane polymer in the presence of the small molecules which acted as hydrophobing treating agents of the silica resulting in the in-situ treatment of the silica whilst the silica and polymer are being mixed. As previously indicated the polymer used may be component (i) or a mixture of component (i) and another polymer if desired but in this case no component (i) is present in the masterbatch.

TABLE 1
Fumed Silica Masterbatch

| | Wt. % |
|---|---|
| Fumed silica | 29.7% |
| Vinyl-terminated siloxane polymer | 62.4% |
| HMDZ | 5.5% |
| Divinyl teteramethyldisilazane | 0.3% |
| Methylvinyl diol (MVD) | 0.35% |
| Water | 1.75% |

Several LSR compositions were prepared as examples (Ex. 1-11) and comparative examples (comp. 1-9) in two-part compositions.

Prior to mixing, the part A composition incorporated the following: High vinyl siloxane copolymer,
A proportion of the masterbatch depicted in Table 1,
Platinum catalyst,
ZrAcAc Masterbatch and
a proportion of eco-solvent. The eco-solvent is designed to evaporate during the cure process.

The part B composition incorporated the following:
Remainder of the masterbatch,
Resinous SiH crosslinker,
Inhibitor when present, as well as the silane 1, 2 and/or 3 and the remainder of the eco-solvent present. The eco-solvent is designed to evaporate during the cure process.

Shortly prior to use the Part A compositions and their respective part B compositions were mixed together in a 1:1 weight ratio to make the final silicone/polyurethane synthetic leather topcoat composition under test.

In the following examples once mixed the silicone/polyurethane synthetic leather topcoat compositions prepared were applied onto a pre-prepared polyurethane composite material having a textile support layer, a foam adhesion layer laminated to the former and a beige coloured polyurethane (PU) skin layer which was prepared using a polyether polyol. The topcoat used in each example/comparative example was applied onto the PU skin layer and cured for approximately 5 minutes in an oven at an average temperature of 150° C.

TABLE 2a
Part A compositions for Ex. 1 to 7 (wt. %)

| | Ex. 1 | Ex. 2 | Ex. 3 | Ex. 4 | Ex. 5 | Ex. 6 | Ex. 7 |
|---|---|---|---|---|---|---|---|
| Fumed silica LSR master batch | 0.00 | 8.00 | 7.00 | 7.00 | 10.94 | 40.00 | 24.00 |
| (29.7% silica, 62% low vinyl PDMS | | | | | | | |
| polymer) | | | | | | | |
| High vinyl PDMS polymer | 6.30 | 2.30 | 6.30 | 6.30 | 5.00 | 0.00 | 0.00 |
| Vinyl-terminated siloxane | 24.55 | 17.69 | 15.69 | 15.69 | 21.48 | 6.70 | 6.70 |
| copolymer 2 | | | | | | | |
| Methyl vinyl diol (MVD) | 3.95 | 3.95 | 3.95 | 3.95 | 5.30 | 0.00 | 0.00 |
| Silicone elastomer powder | 26.02 | 24.70 | 27.92 | 27.92 | 7.02 | 0.00 | 16.00 |
| ZrAcAc Masterbatch | 2.00 | 3.00 | 2.00 | 4.00 | 3.00 | 3.00 | 3.00 |
| Eco-solvent | 36.78 | 40.00 | 36.78 | 34.78 | 47.00 | 50.00 | 50.00 |
| Platinum catalyst solution | 0.4 | 0.36 | 0.36 | 0.36 | 0.26 | 0.30 | 0.30 |

TABLE 2b
Part B compositions for Ex. 1 to 7 (wt. %)

| | Ex. 1 | Ex. 2 | Ex. 3 | Ex. 4 | Ex. 5 | Ex. 6 | Ex. 7 |
|---|---|---|---|---|---|---|---|
| Fumed silica | 40.88 | 35.86 | 40.08 | 40.08 | 24.31 | 37.98 | 37.98 |
| LSR master batch | | | | | | | |
| (29.7% silica, 62% low | | | | | | | |
| vinyl PDMS polymer) | | | | | | | |
| Vinyl-terminated | 8.22 | 8.50 | 9.00 | 9.00 | 12.57 | 3.42 | 3.42 |
| siloxane copolymer 2 | | | | | | | |
| Eco-solvent | 36.78 | 40.00 | 36.78 | 34.78 | 46.00 | 50.00 | 50.00 |
| Silane 1 | 2.00 | 3.50 | 2.00 | 4.00 | 4.00 | 3.50 | 3.50 |
| Inhibitor | 0.08 | 0.10 | 0.1 | 0.1 | 0.08 | 0.10 | 0.10 |
| Resinous Si-H crosslinker | 12.04 | 12.04 | 12.04 | 12.04 | 13.04 | 5.00 | 5.00 |
| containing M(H) | | | | | | | |
| functions | | | | | | | |

TABLE 3a
Part A compositions for Examples 8-11 and Comparative
examples . 1-3 (wt. %)

| | Ex. 8 | Ex. 9 | Ex. 10 | Ex. 11 | C. 1 | C. 2 | C. 3 |
|---|---|---|---|---|---|---|---|
| Fumed silica LSR master | 24.00 | 9.50 | 9.50 | 9.50 | 10.94 | 8 | 8 |
| batch (29.7% silica, | | | | | | | |
| 62% low vinyl PDMS | | | | | | | |
| polymer) | | | | | | | |
| High vinyl PDMS | 0.00 | 4.00 | 4.00 | 4.00 | 5 | 22.69 | 22.69 |
| polymer | | | | | | | |
| Vinyl-terminated | 6.70 | 15.19 | 15.19 | 15.19 | 21.48 | | |
| siloxane copolymer 2 | | | | | | | |
| Methyl vinyl | 0.00 | 3.95 | 3.95 | 3.95 | 5.3 | | |
| diol (MVD) | | | | | | | |
| Silicone elastomer | 16.00 | 24.00 | 25.00 | 24.00 | 7.02 | 14.05 | 14.05 |
| powder | | | | | | | |
| ZrAcAc | 3.00 | 3.00 | 2.00 | 3.00 | | | 0.5 |
| Masterbatch | | | | | | | |
| Eco-solvent | 50.00 | 40.00 | 40.00 | 40.00 | 50 | 55 | 54.40 |
| Platinum catalyst | 0.30 | 0.36 | 0.36 | 0.36 | 0.26 | 0.26 | 0.36 |
| solution | | | | | | | |

TABLE 3b
Part B compositions for Examples 8-11 and Comparative examples. 1-3 (wt. %)

| | Ex. 8 | Ex. 9 | Ex. 10 | Ex. 11 | C. 1 | C. 2 | C. 3 |
|---|---|---|---|---|---|---|---|
| Fumed silica LSR master batch | 37.98 | 33.36 | 33.36 | 33.36 | 24.31 | 26.88 | 26.88 |
| (29.7% silica, 62% low vinyl | | | | | | | |
| PDMS polymer) | | | | | | | |
| Vinyl-terminated siloxane | 3.42 | 11.00 | 12.50 | 11.00 | 12.57 | | |
| copolymer 2 | | | | | | | |
| Eco-solvent | 50.00 | 40.00 | 40.00 | 40.00 | 50 | 60 | 59.60 |
| Silane 1 | 3.50 | 2.50 | | | | | 0.4 |
| Silane 2 | | 1.00 | 2.00 | 3.50 | | | |
| Inhibitor | 0.10 | 0.10 | 0.10 | 0.10 | 0.08 | 0.08 | 0.08 |
| Resinous Si-H crosslinker | | 12.04 | 12.04 | 12.04 | 13.04 | 13.04 | 13.04 |
| containing M(H) functions | | | | | | | |
| Trimethylsiloxy terminated Si-H | 5.00 | | | | | | |
| cross linker | | | | | | | |

TABLE 4a
Part A compositions for Comparative examples. 4 to 9 (wt. %)

| | C. 4 | C. 5 | C. 6 | C. 7 | C. 8 | C. 9 |
|---|---|---|---|---|---|---|
| Fumed silica LSR master batch (29.7% | 8.45 | 8.00 | 10.94 | 10.94 | 10.94 | 10.94 |
| silica, 62% low vinyl | | | | | | |
| PDMS polymer) | | | | | | |
| High vinyl PDMS polymer | 3.86 | 22.69 | 5.00 | 5.00 | 5.00 | 5.00 |
| Vinyl-terminated | 16.5 | | 21.48 | 21.48 | 21.48 | 21.48 |
| siloxane copolymer 2 | | | | | | |
| Methyl vinyl diol (MVD) | 4.09 | | 5.30 | 5.30 | 5.30 | 5.30 |
| Silicone elastomer powder | 28.59 | 14.05 | 7.02 | 7.02 | 7.02 | 7.02 |
| ZrAcAc Masterbatch | 2.00 | 3.00 | 0.5 | 4.00 | | |
| Eco-solvent | 36.15 | 51.90 | 49.50 | 46.00 | 50.00 | 50.00 |
| Platinum catalyst | 0.36 | 0.36 | 0.26 | 0.26 | 0.26 | 0.26 |
| solution | | | | | | |

TABLE 4b
Part B compositions for Comparative examples. 4 to 9 (wt. %)

| | C. 4 | C. 5 | C. 6 | C. 7 | C. 8 | C. 9 |
|---|---|---|---|---|---|---|
| Fumed silica LSR master | 24.31 | 26.88 | 24.31 | 24.31 | 24.31 | 24.31 |
| batch (29.7% silica, | | | | | | |
| 62% low vinyl PDMS polymer) | | | | | | |
| Vinyl-terminated | 12.57 | | 12.57 | 12.57 | 12.57 | 12.57 |
| siloxane copolymer 2 | | | | | | |
| Eco-solvent | 48.00 | 56.50 | 49.60 | 50.00 | 46.00 | 46.00 |
| Silane1 | | 3.50 | 0.4 | | 4.00 | |
| Silane 2 | | | | | | 4.00 |
| Silane 3 | 2.00 | | | | | |
| Inhibitor | 0.08 | 0.08 | 0.08 | 0.08 | 0.08 | 0.08 |
| Resinous Si-H crosslinker | 13.04 | 13.04 | 13.04 | 13.04 | 13.04 | 13.04 |
| containing M(H) | | | | | | |
| functions | | | | | | |

Once cured the resulting silicone/polyurethane composite synthetic leather material had a topcoat with an average dry film thickness of between 20 and 25 μm. Upon inspection it was found that the examples generally exhibited a matting appearance.

All examples underwent testing for Easy to clean performance and scratch resistance.

Easy to clean performance was undertaken by marking ball pen on the surface of the cured topcoat of the silicone/polyurethane composite synthetic leather material under test and then checking whether all ball pen marks can be directly cleaned by using tissue paper or medical gauze within 5 minutes. If all ball pen marks can be fully cleaned for more times in same area of one leather sample, this means more excellent easy to clean performance.

Scratch resistance was carried out in accordance with the FORD FLTM BN 108-13 test Which is designed to determine the resistance to scratching on surfaces of plastic or other materials under standard conditions. In this technique, a scratch testing apparatus is utilised per the test requirements and subsequently an observer uses a controlled light source to visually inspect the presence or absence of a scratch line and rates according to a Rating Scale 1 to 5 (1=no scratch line at all; 5=severe scratch line).

TABLE 5a
Easy to clean and Scratch resistance testing for Examples 1 to 11

| | | Ex. 2, 3, | Ex. 6, | Ex. | Ex. | Ex. |
|---|---|---|---|---|---|---|
| | Ex. 1 | 4 & 5 | 7, 8 | 9 | 10 | 11 |
| Repeated easy-to-clean | 4 | >5 | 4 | >5 | 5 | >5 |
| performance (Times) | | | | | | |
| Scratch resistance test | 1~2 | 1~2 | 1~2 | 1~2 | 1~2 | 1~2 |
| (silicone coated on | | | | | | |
| surface of PU skin layer) | | | | | | |

TABLE 5b
Easy to clean and Scratch resistance testing for Comparative
Examples 1 to 9

| | | | | | | | C. 7, 8 |
|---|---|---|---|---|---|---|---|
| | C. 1 | C. 2 | C. 3 | C. 4 | C. 5 | C. 6 | & 9 |
| Repeated | 1 | 0~1 | 0~1 | 1 | 0~1 | 1~2 | 0~1 |
| easy-to-clean | | | | | | | |
| performance | | | | | | | |
| (Times) | | | | | | | |
| Scratch | 4~5 | 4~5 | 3~4 | 2~3 | 1~2 | 3~4 | 4~5 |
| resistance test | | | | | | | |
| (silicone coated on | | | | | | | |
| surface of | | | | | | | |
| PU skin layer) | | | | | | | |

It was noted that after the scratch resistance tests on the comparative examples that some delamination was observed after undergoing the scratching step. This was not observed on the examples. It can be seen from the results the examples in support of the disclosure in Table 5a all had an easy to clean performance of at least 4 whereas the results on the comparatives in Table 5b gave much worse results. Similarly, the scratch resistance results are consistently better with the examples herein. It is believed that the stain resistance (easy to clean) results herein were due to stable bonding between the silicone/polyurethane synthetic leather topcoat composition and the PU skin layer (after the former was cured). One major advantage of the silicone/polyurethane composite synthetic leather material given the high performance shown is the competitiveness of the manufacturing costs (high performance/price ratio) especially compared to pure silicone leather.

1. A silicone/polyurethane synthetic leather topcoat composition comprising:
(i) at least one organopolysiloxane polymer having at least two unsaturated groups per molecule which unsaturated groups are selected from alkenyl groups, alkynyl groups or a mixture thereof; having a viscosity of from 100 to 500,000 mPa·s at 25° C.;
(ii) an inorganic reinforcing filler optionally hydrophobically treated with one or more filler treating agents;
(iii) a polyorganosiloxane containing at least two or optionally at least three silicon bonded hydrogen (—Si—H) groups per molecule;
(iv) a hydrosilylation catalyst;
(v) an adhesion promoter comprising a combination of zirconium acetylacetonate in an amount of from 1 to 5 wt. % of the composition with
1,3,5-tris[3-(trimethoxysilyl)propyl]-1,3,5-triazine-2,4,6(1H,3H,5H)-trione, and/or one or more epoxy silanes of the formula 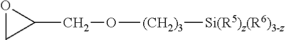
wherein R⁵ is an alkyl group having 1 to 6 carbons, R⁶ is an alkoxy group having 1 to 6 carbons and z=0, 1 or 2, or a mixture thereof, in an amount of from 1 to 6 wt. % of the composition; and
(vi) an eco-solvent; and optionally
(vii) a cured silicone powder.

2. The silicone/polyurethane synthetic leather topcoat composition in accordance with claim 1, wherein component (iii) comprises one or more of the following:
silicone resins comprising or consisting of Si—H containing groups, (CH₃)₃SiO_{1/2} groups and SiO_{4/2} groups,
silicone resins comprising or consisting of Si—H containing groups and SiO_{4/2} groups,
silicone resins comprising or consisting of Si—H containing groups, (CH₃)₂SiO_{2/2} groups and SiO_{4/2} groups,
silicone resins comprising or consisting of Si—H containing groups, SiO_{4/2} groups and (C₆H₅)₃SiO_{1/2} groups,
wherein each of the above may include one or more CH₃—SiO_{3/2} (T) groups and alternatives in which methyl is replaced by phenyl groups or other alkyl groups or mixtures thereof.

3. The silicone/polyurethane synthetic leather topcoat composition in accordance with claim 1, wherein component (vii) is present and wherein the cured silicone elastomer powder (vii) has an average particle size of from 0.01 to 100 μm.

4. The silicone/polyurethane synthetic leather topcoat composition in accordance with claim 1, wherein the eco-solvent (vi) comprises or consists of isopentadecane, isohexadecane, isoheptadecane, isooctadecane, isononadecane and mixtures thereof or trimethyl terminated polydimethylsiloxane having a viscosity of from greater than or equal to (≥) 5 mPa·s at 25° C. to equal or less than (≤) 100 mPa·s at 25° C.

5. The silicone/polyurethane synthetic leather topcoat composition in accordance with claim 1, additionally comprising one or more of the following additives: cure inhibitors, cured silicone elastomer powder, pot life extenders, lubricants, flame retardants, pigments, colouring agents, heat stabilizers, compression set improvement additives, anti-squeak agents and mixtures thereof.

6. The silicone/polyurethane synthetic leather topcoat composition in accordance with claim 1, wherein the epoxysilane of component (v) is present and selected from one or more of the following: 3-glycidoxypropyltrimethoxysilane,
3-glycidoxypropyltriethoxysilane, (3-glycidoxypropyl)methyldiethoxysilane, and (3-glycidoxypropyl)methyldimethoxysilane.

7. A silicone/polyurethane composite synthetic leather material comprising a topcoat which is the reaction product of the composition in accordance with claim 1 obtained upon cure.

8. The silicone/polyurethane composite synthetic leather material in accordance with claim 7, comprising the following layers:
(a) a textile support layer;
(b) a sponge/adhesive layer adhered to layer (a);
(c) a polyurethane skin layer adhered to layer (b); and
(d) the topcoat
wherein layer (b) is substantially sandwiched between layers (a) and (c) and layer (c) is substantially sandwiched between layers (b) and (d).

9. A method of preparing a silicone/polyurethane composite synthetic leather material having a topcoat, the method comprising the step of:
adhering and curing the silicone/polyurethane synthetic leather topcoat composition in accordance with claim 1 to a suitable-polyurethane skin layer.

10. A method of preparing a silicone/polyurethane composite synthetic leather material having a topcoat, the method comprising the following steps:
applying a polyurethane skin layer (c) onto a release liner and then drying the polyurethane skin layer (c);
applying a sponge/adhesion layer (b) onto the polyurethane skin layer (c) and applying a textile support layer (a) on the side of the sponge/adhesion layer (b) remote from the polyurethane skin layer (c) by lamination commencing prior to drying the sponge/adhesion layer (b) or after the same has been partially dried; to form a partially prepared silicone/polyurethane composite synthetic leather material;
when required, removing the release liner; and
applying and curing a layer of the silicone/polyurethane synthetic leather topcoat composition (d) in accordance with claim 1 on the polyurethane skin layer (c).

11. A method of preparing a silicone/polyurethane composite synthetic leather material with a topcoat, the method comprising the following steps:
applying and curing a silicone/polyurethane synthetic leather topcoat composition in accordance with claim 1 onto a release liner to form a silicone/polyurethane synthetic leather topcoat (d);
applying and then drying a polyurethane skin layer (c) on the cured silicone/polyurethane synthetic leather topcoat (d);
applying a sponge/adhesion layer (b) onto the polyurethane skin layer (c); and
applying a textile support layer (a) on the side of the sponge/adhesion layer (b) remote from the polyurethane skin layer (c) by lamination commencing prior to drying the sponge/adhesion layer (b) or after the same has been partially dried.

12. The method of preparing a silicone/polyurethane composite synthetic leather material with a topcoat in accordance with claim 9, wherein the silicone/polyurethane synthetic leather topcoat composition is applied and cured to give a dry film thickness of about 2 to about 50 μm.

13. The method of preparing a silicone/polyurethane composite synthetic leather material with a topcoat in accordance with claim 9, wherein the silicone/polyurethane synthetic leather topcoat composition is applied using one or more of the following techniques selected from spraying, rolling, brushing, spin coating, dip coating, solvent casting, slot die coating, spray coating, knife coating, or gravure coating.

14. The method of preparing a silicone/polyurethane composite synthetic leather material with a topcoat in accordance with claim 9, wherein the polyurethane skin layer is activated, prior to being coated with the silicone/polyurethane synthetic leather topcoat composition, using an activation method selected from plasma treatment, corona discharge treatment, UV-C/ozone or vacuum-UV irradiation.

15. (canceled)
